(19) United States
(12) Patent Application Publication
(10) Pub. No.: US 2022/0142856 A1
(43) Pub. Date: May 12, 2022

(54) MASSAGE DEVICE

(71) Applicant: BIBOTING INTERNATIONAL CO., LTD., TAOYUAN CITY (TW)

(72) Inventors: Po-Chang LIU, TAOYUAN CITY (TW); Li-Pin YUAN, TAOYUAN CITY (TW)

(21) Appl. No.: 17/165,280

(22) Filed: Feb. 2, 2021

(30) Foreign Application Priority Data
Nov. 12, 2020 (TW) 109214925

(51) Int. Cl. A61H 23/02; A61H 7/00

(52) U.S. Cl. CPC A61H 23/0254; A61H 7/008; A61H 2201/0157; A61H 2201/1215; A61H 2201/0153; A61H 2201/5097

(57) ABSTRACT

The invention provides a massage device, which includes a housing, a massage head, a vibration motor, and a control module. The massage head is disposed in and exposed from the housing. The vibration motor is disposed in the housing. The control module is disposed in the housing and electrically connected to the vibration motor, and includes a changeover switch, a Bluetooth communication chip, and a Bluetooth antenna. When the vibration motor is operated, the changeover switch selectively sets the vibration motor to one of multiple preset rotating speeds. The Bluetooth communication chip receives a signal through the Bluetooth antenna to make the control module selectively set the vibration motor to one rotating speed in a rotation speed range. The preset rotating speeds are in the rotating speed range.

### BACKGROUND OF THE INVENTION

### Technical Field

The invention relates to massage devices, particularly to a wirelessly controllable massage device.

### Related Art

A related-art massager generally includes a motor and a massage head. The massage head is used for touching and massaging a human body by vibration of the motor. A related-art massager may be connected with a negative-pressure device to perform massage by a suction manner. Thus, a massager must be connected with a pipe and a wire, such as negative-pressure pipeline and power cord. When a user is operating such a massager, the vision and action may be interfered by those elements. This is inconvenient for the user.

In view of this, the inventors have devoted themselves to the above-mentioned related art, researched intensively and cooperated with the application of science to try to solve the above-mentioned problems. Finally, the invention which is reasonable and effective to overcome the above drawbacks is provided.

### SUMMARY OF THE INVENTION

The invention provides a massage device which is controlled wirelessly.

The invention provides a massage device, which includes a housing, a massage head, a vibration motor, and a control module. The massage head is disposed in and exposed from the housing. The vibration motor is disposed in the housing. The control module is disposed in the housing and electrically connected to the vibration motor, and includes a changeover switch, a Bluetooth communication chip, and a Bluetooth antenna. When the vibration motor is operated, the changeover switch selectively sets the vibration motor to one of multiple preset rotating speeds. The Bluetooth communication chip receives a signal through the Bluetooth antenna to make the control module selectively set the vibration motor to one rotating speed in a rotation speed range. The preset rotating speeds are in the rotating speed range.

The massage device of the invention further includes a mobile controller communicationally connected with the control module. When the vibration motor is operated, the mobile controller selectively set the vibration motor to one rotating speed in the rotation speed range.

The massage device of the invention further includes a connector head arranged on the housing. A tube is disposed in the connector head. The massage head includes a negative-pressure chamber communicating with the tube. The connector head includes an electric connector electrically connected to the control module.

In the massage device of the invention, the housing includes a switching key exposed from an outer surface of the housing and abutting against the changeover switch. The control module includes a power switch, and the housing includes a power key exposed form an outer surface of the housing and abutting against the power switch. The control module includes a circuit board, and the changeover switch and the power switch are arranged on the same side of the circuit board. The Bluetooth communication chip and the Bluetooth antenna are separately arranged on two sides of the circuit board. The Bluetooth antenna is arranged on an edge of the circuit board. The changeover switch and the Bluetooth communication chip are arranged on the same side of the circuit board.

The massage device of the invention may have a changeover switch for circulatory changeover to rapidly set the vibration motor to one of multiple preset rotating speeds. The mobile controller may fine-tune and set the vibration motor to any rotating speed through the Bluetooth communication chip and the Bluetooth antenna. Further, a user may operate the mobile controller to set the rotating speed of the vibration motor to prevent the operation from the interference of the pipelines.

### BRIEF DESCRIPTION OF THE DRAWINGS

FIGS. 1 and 2 are schematic views of the massage device of an embodiment of the invention;

FIGS. 3 and 4 are exploded views of the massage device of an embodiment of the invention;

FIGS. 5 and 6 are schematic views of the control module of the massage device of an embodiment of the invention;

FIG. 7 is a longitudinal section view of the massage device of an embodiment of the invention; and

FIG. 8 is schematic view of the controller of the massage device of an embodiment of the invention in use.

### DETAILED DESCRIPTION OF THE INVENTION

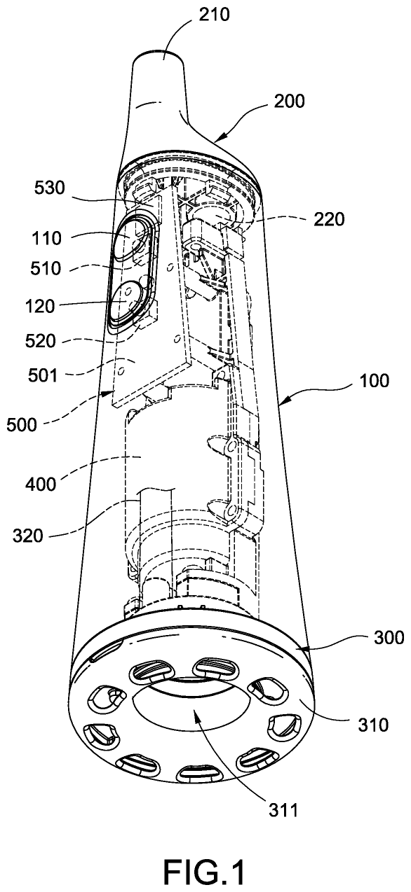

Please refer to FIG. 1 to FIG. 4, the first embodiment of the invention provides a massage device, which includes a housing 100, a massage head 300, a vibration motor 400 and a control module 500.

In this embodiment, the housing 100 is of a tubular shape for holding, but not limited to this shape.

The massage head 300 is disposed in and exposed from the housing 100 to be in contact with a user's skin. In this embodiment, the massage head 300 is disposed on one end of the housing 100. In detail, the massage head 300 includes a base 301 and a plastic cover 310. The base 301 is fixed in the housing 100. The plastic cover 310 is sheathed on the base 301 and exposed from the housing 100 to be in contact with the user's skin. The center of the plastic cover 310 is dented inwardly to the housing 100 to form a negative-pressure chamber 311.

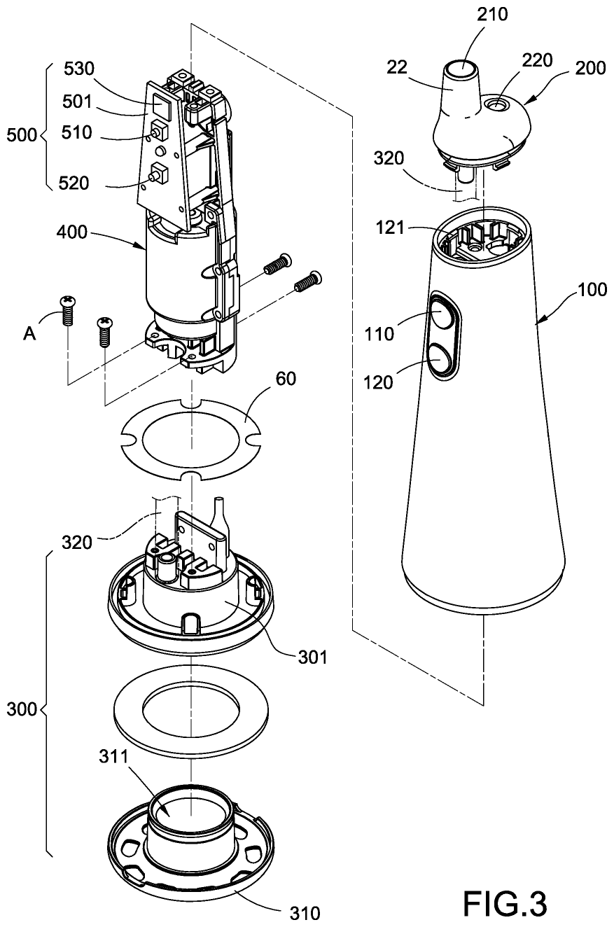

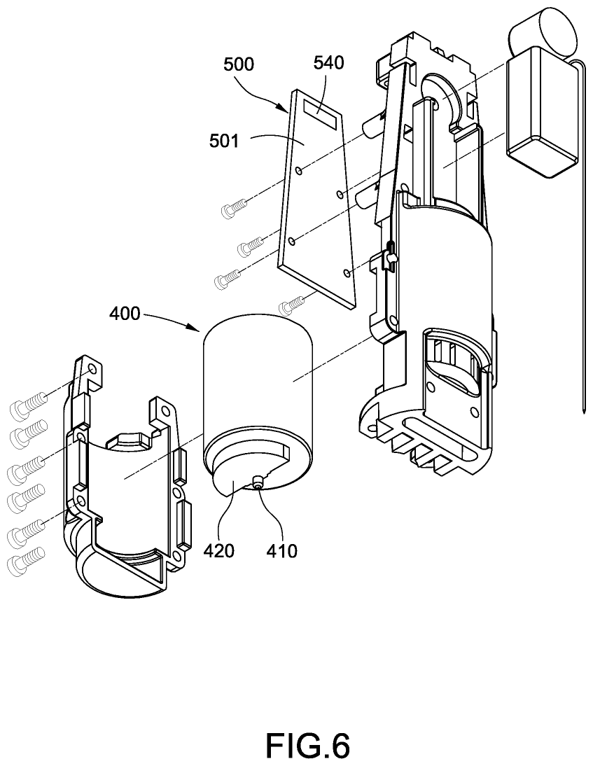

Please refer to FIG. 3 to FIG. 6, the vibration motor 400 is disposed in the housing 100. The vibration motor 400 has a drive shaft 410. The drive shaft 410 is connected with an eccentric rotor 420. When the vibration motor 400 is operated, the eccentric rotor 420 is driven to eccentrically rotate with respect to the drive shaft 410 as a central axis to make vibration. The control module 500 is disposed in the housing 100 and is electrically connected to the vibration motor 400. In this embodiment, the control module 500 includes a circuit board 501. A control circuit (not shown in figures) is disposed on the circuit board 501. The control circuit is electrically connected to the vibration motor 400 to control the operation of the vibration motor 400. The circuit board 501 is further provided with a changeover switch 510, a Bluetooth communication chip 530 and a Bluetooth antenna 540, which are electrically connected with the control circuit respectively. The control module 500 may include a power switch 520 disposed on the circuit board 501 to drive the control circuit to control the electric connector 220 for connecting/disconnecting power to the circuit board 501. When the vibration motor 400 is operated, the changeover switch 510 may drive the control circuit to selectively set the vibration motor 400 to one of multiple preset rotating speeds. The Bluetooth antenna 540 is a channel of transceiving a Bluetooth signal. The Bluetooth communication chip 530 is used for processing the signals received by the Bluetooth antenna 540 for the control module on the circuit board 501 to control the operation of the vibration motor 400.

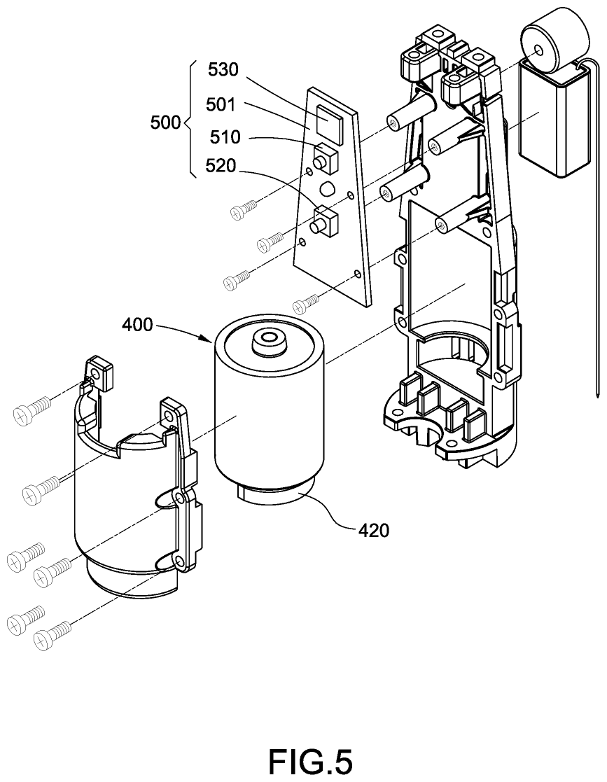

Please refer to FIG. 5 to FIG. 7, the changeover switch 510 and the power switch 520 are arranged on the same side of the circuit board 501. The Bluetooth communication chip 530 and the Bluetooth antenna 540 are arranged on two sides of the circuit board 501 respectively. The changeover switch 510 and the Bluetooth communication chip 530 are arranged on the same side of the circuit board 501. The Bluetooth antenna 540 is arranged on an edge of the circuit board 501 so as to prevent the Bluetooth antenna 540 from being interfered by other electronic components on the circuit board 501.

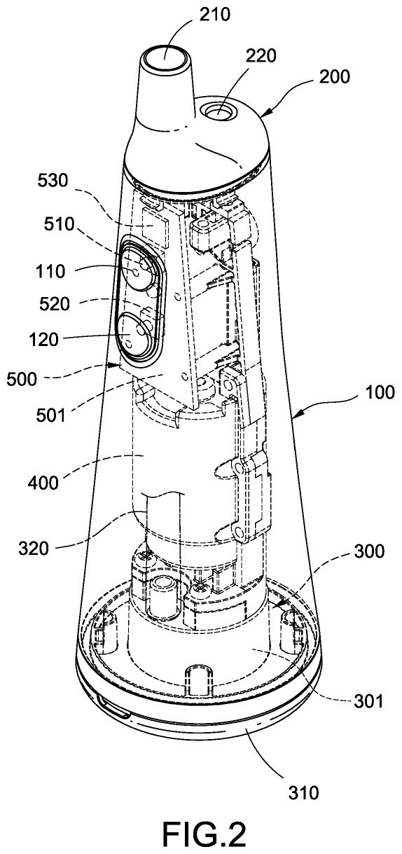

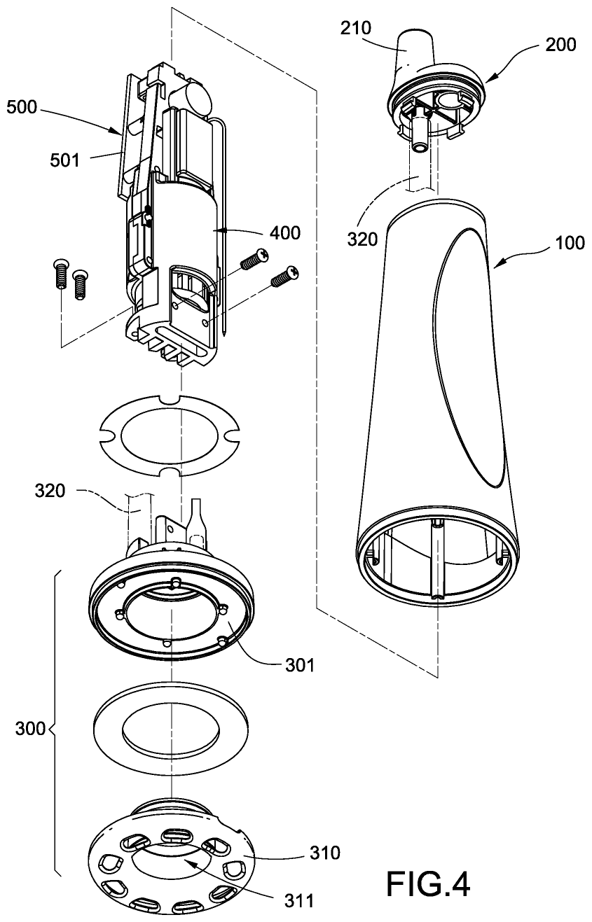

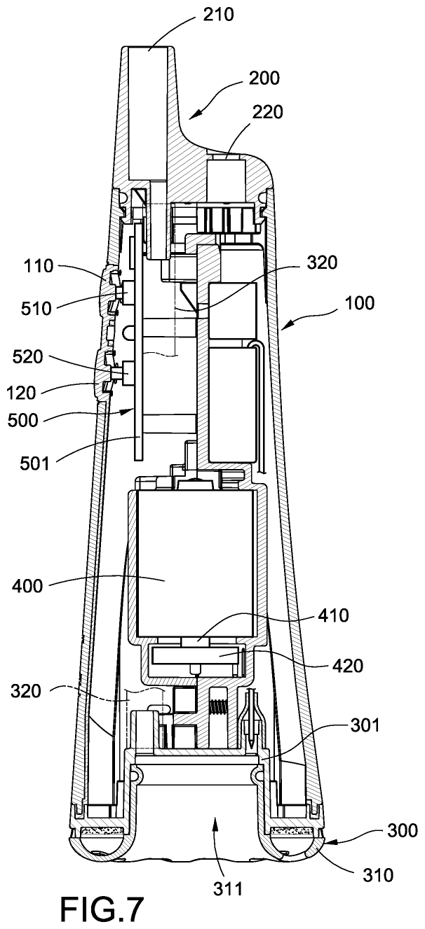

Please refer to FIG. 2, FIG. 4 and FIG. 7, the massage device of the invention may include a connector head 200 for connecting an air pressure source and a power source. In this embodiment, the connector head 200 is arranged on the other end of the housing 100. The connector head 200 is provided with a tube 210. An end of the tube 210 is exposed to be connected with a pipeline of the air pressure source and the other end of the tube 210 is extended into the housing 100 to communicate with the negative-pressure chamber 311. In this embodiment, the tube 210 and the negative-pressure chamber 311 are connected by a communication pipe 320 to communicate with each other. In some embodiments, the communication pipe 320 is a soft pipe such as, but not limited to, a silicone pipe or a rubber pipe. The connector head 200 may be further provided with an electric connector 220. The electric connector 220 is exposed and is electrically connected to the control module 500 for connecting with a power cord to supply electric power to the control module 500 and the vibration motor 400.

Please refer to FIG. 1 to FIG. 4 and FIG. 7, the housing 100 is disposed with a switching key 110 exposed from an outer surface of the housing 100 and abutting against the changeover switch 510. The housing 100 is provided with a power key 120 exposed form the outer surface of the housing 100 and abutting against the power switch 520. As a result, a user may press the power key 120 and the switching key 110 to switch the power switch 520 and the changeover switch 510, respectively.

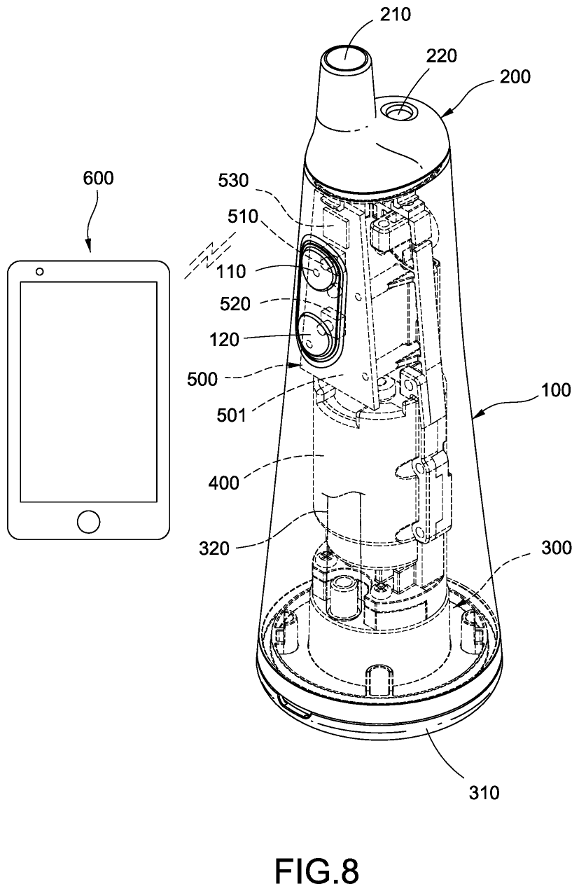

Please refer to FIG. 8, the massage device of the invention may further include a mobile controller 600. The mobile controller 600 is a communication device with a touch screen and a Bluetooth communication function, such as a tablet or a mobile phone. The mobile controller 600 is communicationally connected with the control module 500 through the Bluetooth antenna 540 and the Bluetooth communication chip 530. When the vibration motor 400 is operated, the mobile controller 600 may selectively set the vibration motor 400 to any rotating speed in a preset rotation speed range. The preset rotating speeds are in the rotating speed range. The rotating speed range is the predetermined upper and lower limits of rotating speed depending on the performance of the vibration motor 400 and the using requirements. The rotating speed range is not limited herein.

In summary, the massage device of the invention may have a changeover switch 510 for circulatory changeover to rapidly set the vibration motor 400 to one of multiple preset rotating speeds. The mobile controller 600 may fine-tune and set the vibration motor to any rotating speed through the Bluetooth communication chip 530 and the Bluetooth antenna 540. Further, a user may operate the mobile controller 600 to set the rotating speed of the vibration motor 400 to prevent the operation from the interference of the pipelines.

It will be appreciated by persons skilled in the art that the above embodiment has been described by way of example only and not in any limitative sense, and that various alterations and modifications are possible without departure from the scope of the invention as defined by the appended claims.

What is claimed is:

1. A massage device comprising:
a housing;
a massage head, disposed in and exposed from the housing;
a vibration motor, disposed in the housing; and
a control module, disposed in the housing, electrically connected to the vibration motor, and comprising a changeover switch, a Bluetooth communication chip, and a Bluetooth antenna;
wherein when the vibration motor is operated, the changeover switch selectively set the vibration motor to one of multiple preset rotating speeds, the Bluetooth communication chip receives a signal through the Bluetooth antenna to make the control module selectively set the vibration motor to one rotating speed in a rotation speed range, and the preset rotating speeds are in the rotating speed range.

2. The massage device of claim 1, further comprising: a mobile controller, communicationally connected with the control module through the Bluetooth antenna and the Bluetooth communication chip, wherein when the vibration motor is operated, the mobile controller selectively set the vibration motor to one rotating speed in the rotation speed range.

3. The massage device of claim 1, further comprising: a connector head, arranged on the housing, a tube disposed in the connector hear, and the massage head comprising a negative-pressure chamber communicating with the tube.

4. The massage device of claim 3, further comprising: a communication pipe, passing through the housing to connect between the tube and the negative-pressure chamber.

5. The massage device of claim 3, wherein the connector head comprises an electric connector electrically connected to the control module.

6. The massage device of claim 1, wherein the housing comprises a switching key exposed from an outer surface of the housing and abutting against the changeover switch.

7. The massage device of claim 1, wherein the control module comprises a power switch, and the housing comprises a power key exposed form an outer surface of the housing and abutting against the power switch.

8. The massage device of claim 7, wherein the control module comprises a circuit board, and the changeover switch and the power switch are arranged on a same side of the circuit board.

9. The massage device of claim 1, wherein the control module comprises a circuit board, and the Bluetooth communication chip and the Bluetooth antenna are separately arranged on two sides of the circuit board.

10. The massage device of claim 9, wherein the Bluetooth antenna is arranged on an edge of the circuit board.

11. The massage device of claim 9, wherein the changeover switch and the Bluetooth communication chip are arranged on a same side of the circuit board.
